(19) United States
(12) Patent Application Publication
(10) Pub. No.: US 2015/0095206 A1
(43) Pub. Date: Apr. 2, 2015

(54) SYSTEMS AND METHODS FOR PROVIDING TRANSACTION COMPLETION ALERTS

(71) Applicants: Lauren VAN HEERDEN, Bedford, NH (US); Gunalan NADARAJAH, Milton (CA); Orin DEL VECCHIO, Richmond Hill (CA); Michael D. CUMMINS, Pickering (CA); Prabaharan SIVASHANMUGAM, Farmington Hills, MI (US)

(72) Inventors: Lauren VAN HEERDEN, Bedford, NH (US); Gunalan NADARAJAH, Milton (CA); Orin DEL VECCHIO, Richmond Hill (CA); Michael D. CUMMINS, Pickering (CA); Prabaharan SIVASHANMUGAM, Farmington Hills, MI (US)

(73) Assignee: The Toronto-Dominion Bank, Mississauga (CA)

(21) Appl. No.: 14/199,664

(22) Filed: Mar. 6, 2014

Related U.S. Application Data
(60) Provisional application No. 61/884,798, filed on Sep. 30, 2013.

(51) Int. Cl. G06Q 40/00

(52) U.S. Cl. CPC G06Q 40/00
USPC 705/35

(57) ABSTRACT

Systems and methods are provided for identifying interrupted transactions and automatically completing interrupted transactions based on responses to transaction completion alerts. The disclosed embodiments may include a server that may obtain one or more first terms of a transaction from a customer. The server may be configured to identify an interruption in an execution of the transaction, and determine, in response to the identified interruption, whether the first transaction terms include a predetermined subset of second transaction terms used to execute the transaction. The server may also complete the execution of the interrupted transaction when the first transaction terms include at least the predetermined subset of the second transaction terms.

### CROSS-REFERENCE TO RELATED APPLICATION(S)

This application claims the benefit of priority to U.S. Provisional Patent Application No. 61/884,798, filed Sep. 30, 2013, the entire disclosure of which is expressly incorporated herein by reference to its entirety.

### BACKGROUND

1. Technical Field

The present disclosure relates to computerized systems and methods for performing financial transactions in a network environment, such as the Internet. More particularly, and without limitation, the present disclosure relates to computerized systems and methods that identify interruptions in financial transactions and provide customers with alerts that facilitate a completion of the interrupted transaction.

2. Background Information

Today, wireless communications devices, such as laptops, netbooks, cellular phones, smart phones, personal digital assistants, tablets, etc., facilitate an increased engagement between customers and their financial institutions. This increased engagement results in not only a more active management of existing funds on deposit at these financial institutions, but also in an increased participation in credit and investment programs supported by these financial institutions.

Even with wireless communications devices, customers must still pass through a frustrating authentication process to access their account information and request various financial transactions, including the entry of multiple alphanumeric authentication credentials, answers to security questions, and identification of various images specific to the customers' accounts. Furthermore, variations in connectivity and electrical supply characteristics of such wireless communications devices often result in various “interruptions” in the processes by which the customer requests a financial transaction, or alternatively, by which the financial institution processes these transactions. In the face of such interruptions, customers are often forced to repeat a cumbersome authentication process, and in some instances, submit additional requests for services and transactions.

### SUMMARY

The disclosed embodiments include computerized methods and systems for identifying an interruption in an execution of a transaction, and for providing a customer with opportunities to complete the execution of the interrupted transaction without submitting additional authentication credentials or specifying additional values for the transaction terms of the interrupted transaction.

The disclosed embodiments include, for example, a computer-implemented method that obtains one or more first terms of a transaction. In one aspect, the transaction may include a set of second terms used to execute the transaction. The method may include identifying an interruption in an execution of the transaction, and determining, in response to the identified interruption, whether the first transaction terms include a predetermined subset of the second transaction terms. The method includes generating, using at least one processor, one or more first electronic instructions to complete the execution of the transaction, when the first transaction terms include the predetermined subset of the second transaction terms.

The disclosed embodiments also include a system having a storage device and at least one processor coupled to the storage device. The storage device may store software instructions for controlling the at least one processor when executed by the at least one processor. In one embodiment, the at least one processor may be operative with the software instructions and configured to obtain one or more first terms of a transaction. In one aspect, the transaction may include a set of second terms used to execute the transaction. The at least one processor may be further configured to identify an interruption in an execution of the transaction, and determine, in response to the identified interruption, whether the first transaction terms include a predetermined subset of the second transaction terms. The at least one processor may be further configured to generate one or more first electronic instructions to complete the execution of the transaction, when the first transaction terms include the predetermined subset of the second transaction terms.

Other embodiments of the present disclosure relate to a tangible, non-transitory computer-readable medium storing instructions that, when executed by at least one processor, perform a method comprising the process of obtaining one or more first terms of a transaction. The transaction may include a set of second terms used to execute the transaction. The method may further include identifying an interruption in an execution of the transaction, and determining, in response to the identified interruption, whether the first transaction terms include a predetermined subset of the second transaction terms. The method may also include generating, using at least one processor, one or more first electronic instructions to complete the execution of the transaction, when the first transaction terms include the predetermined subset of the second transaction terms.

It is to be understood that both the foregoing general description and the following detailed description are exemplary and explanatory only, and are not restrictive of the disclosed embodiments as claimed. Further, the accompanying drawings, which are incorporated in and constitute a part of this specification, illustrate aspects of the present disclosure and together with the description, and serve to explain principles of the disclosed embodiments as set forth in the accompanying claims.

### BRIEF DESCRIPTION OF THE DRAWINGS

FIG. 1 is a diagram of an exemplary computing environment consistent with disclosed embodiments.

FIG. 2 is a diagram of an exemplary computer system, consistent with disclosed embodiments.

FIG. 3 is a flowchart of an exemplary method for identifying and completing an interrupted transaction, consistent with disclosed embodiments.

FIG. 4 is a diagram of exemplary customer alert, consistent with disclosed embodiments.

FIG. 5 is a flowchart of an exemplary method for completing, cancelling, or delaying execution of an interrupted transaction, consistent with disclosed embodiments.

FIG. 6 is a diagram of exemplary customer alert, consistent with disclosed embodiments.

FIG. 7 is a flowchart of an exemplary method for completing or cancelling execution of an interrupted transaction, consistent with disclosed embodiments.

### DESCRIPTION OF THE EMBODIMENTS

Reference will now be made in detail to embodiments of the present disclosure, examples of which are illustrated in the accompanying drawings. The same reference numbers will be used throughout the drawings to refer to the same or like parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, any section headings used herein are for organizational purposes only, and are not to be construed as limiting the subject matter described.

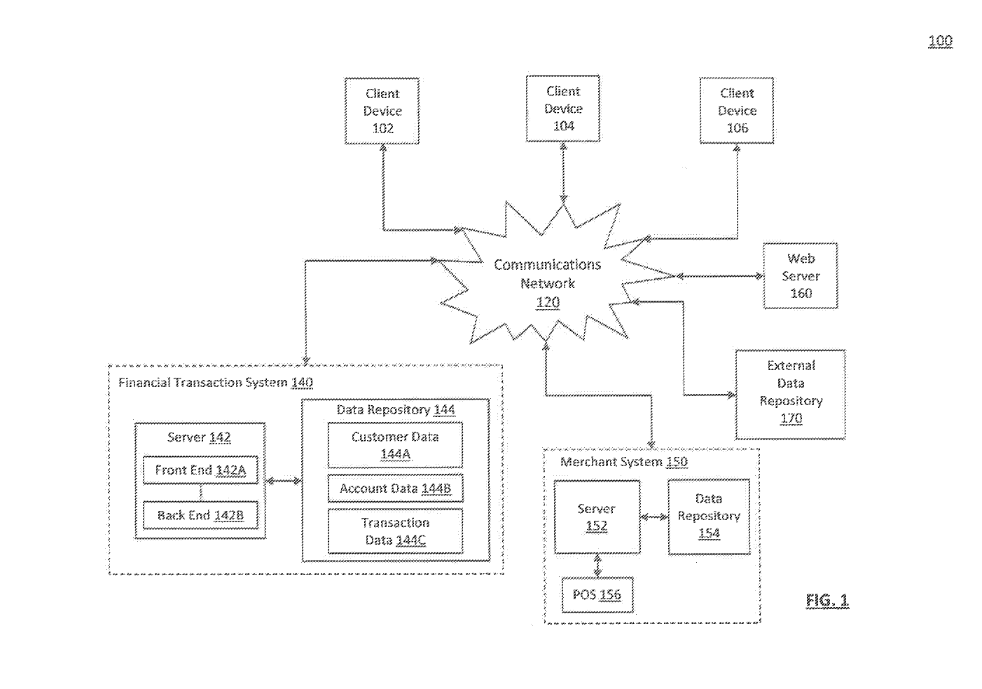

FIG. 1 illustrates an exemplary computing environment 100, consistent with certain disclosed embodiments. In one aspect, system 100 may include a financial transaction system 140, a merchant system 150, a server 160, a data repository 170, and one or more client devices 102, 104, and 106 that may be interconnected via a communications network 120.

In one embodiment, financial transaction system 140 may be one or more computer systems associated with a financial institution, such as, for example, a commercial bank, an investment bank, a broker-dealer, a provider of a payment instrument and financial service accounts, etc. In some embodiments, a financial service account may be a check, savings, credit, debit, and/or a reward or loyalty account. In one embodiment, a payment instrument may include, but is not limited to, a personal or corporate credit card, a debit card, a prepaid credit or debit card, check instruments. These transactions include, but are not limited to, a transfer of funds between financial accounts (e.g., checking, savings, investment, etc.), a payment of a bill, a purchase or sale of a financial instrument or security, a deposit or withdrawal of funds, or an application for credit.

In certain embodiments, financial transaction system 140 may include a server 142 and a data repository 144. Server 142 may be, for example, a transaction server and may include a front end 142A, and a back end 142B disposed in communication with front end 142A, although the configuration of server 142 is not limited to such configurations. For exemplary purposes only, server 142 may be referred to as a transaction server 142. In one example, front end 142A and back end 142B of transaction server 142 may be incorporated into a single computer, a single server, or any additional or alternate computing device apparent to one or skill in the art. In other embodiments, front end 142A and backend 142B may be distributed computing devices. Further, in one embodiment, front end 142A may be one or more software programs, such as a software application (e.g., a web service) executing on transaction server 142. Similarly, backend 142B may be one or more software programs executing on server 142. However, transaction server 142 is not limited to such configurations, and, in additional embodiments, front end 142A can be executed on any computer or server separate from back end 142B.

Transaction server 142 may be configured to execute software instructions to perform one or more processes consistent with the disclosed embodiments. In one embodiment, and client devices 102, 104, and 106 may exchange information and parameters that facilitate an execution of one or more transactions by financial transaction system 140.

Data repository 144 may be one or more data storages configured to store information consistent with the disclosed embodiments. In one aspect, data repository may include customer data 144A, account data 144B, and transaction data 144C. In one aspect, customer data 144A may include one or more data records that uniquely identify one or more customers of a financial institution associated with transaction system 140. By way of example, a customer of the financial institution may access a web page associated with transaction system 140 (e.g., through a web server executed by front end 142A), and may subsequently register for online banking services and provide data, which may be linked to the customer and stored within customer data 144A.

In certain aspects, customer data 144A may include personal information associated with a customer (e.g., a customer name, a home address, a date of birth, government-issued identifiers (e.g., driver's license numbers and Social Security numbers), employment information (e.g., employer name and address), and contact information (e.g., email addresses, home numbers, work numbers, and mobile numbers). Customer data 144A may also include one or authentication credentials associated with registered customers of the financial institution. For example, the authentication credentials may include, but are not limited to, a user name, a user-specified password, a system-generated password, or an alphanumeric identification number (e.g., a PIN number) specified by the user or assigned by financial transaction system 140. Other types of customer information may be stored and used by the disclosed embodiments.

Additionally or alternatively, customer data 144A may include information facilitating enhanced authentication techniques. For example, customer data 144A may store information identifying a security question associated with the customer (e.g., “What is your mother's maiden name?”) and the customer's registered answer to that security question. Customer data 144A may also include information identifying a particular security image or avatar selected by the user and displayed by the user during the authentication process.

Further, in one embodiment, customer data 144A may include user device identification information that identifies one or more devices registered to the user. In one embodiment, the user may provide the user device identification information (e.g., a mobile telephone number provided by the user when registering for online banking services), or alternatively, transaction server 142 may be configured to execute processes that automatically collect user device identification information (e.g., collecting an Internet Protocol (IP) address associated with the customer's smartphone).

Customer data 144A may also include data that enables transaction server 142 to target content to one or more users (e.g., customers of financial institution associated with financial transaction system 140), or alternatively, to identify a peer group of users (e.g., customers) having interests similar to those of a particular user (e.g., a customer). For example, such data may include, but is not limited to, demographic data associated with the group of users (e.g., age group, educational level, income level), social networking data (e.g., “handles” and links to one or more social networking sites), profile data indicating specific interests, and any additional or alternate data that appropriate to the customers and transaction server 142.

In certain aspects, account data 144B may include account identification information identifying one or more accounts of customers of the financial institution associated with transaction system 140. In one embodiment, account identification information may include financial service account information, such as, for example, a checking account, a savings account, a revolving credit line, an account linked to a credit or debit card, a brokerage account, and any additional or alternate account provided or supported by the financial institution. In other embodiments, account data 144B may include information identifying investment portfolios held by one or more customers of the financial institution (e.g., positions in one or more securities held by the customers). In other aspects, account data 144B may include account information associated with non-financial service accounts, such as membership accounts for certain services or activities (e.g., gym membership, prescription drug information, library card, employment identification, student account information, etc.)

In such embodiments, information within account data 144B may identify, for a single customer, one or more accounts associated with the customer and account data corresponding to the accounts (e.g., an account number, expiration date information, and/or card security codes, account balance information, and/or credit limit information.

Transaction data 144C may include information identifying one or more transactions that involve one or more customers of the financial institution associated with financial transaction system 140, and additionally or alternatively, one or more accounts of the one or more customers of the financial institution. In one embodiment, such transactions may include, but are not limited to, purchase transaction (e.g., purchases of goods and/or services from electronic or physical retailers), financial service transactions (e.g., fund transfers (e.g., between accounts), bill payment transactions (e.g., electronic bill payment transactions), financial instrument or security purchases or sales, a deposit or withdrawal of funds, or an application for credit from the financial institution or other entity.

For example, financial transaction system 140 may be configured to execute software instructions that provide an online financial service portal that enables a customer to access a web page of the financial institution to perform financial service type transactions. For instance, financial transaction system 140 may provide an online banking portal that enables a customer to transfer funds between a first customer account to a second account, to schedule automatic bill payment services (e.g., select an amount and periodic payment date for making payments to an identified payee from the customer's selected financial account), and other known types of online financial service processes. For instance, financial transaction server 142 may generate a data record within transaction data 144C that corresponds to the particular service initiated by the customer, such as an initiated transfer of funds, and may populate the data record with information associated with the initiated transaction. As an example, transaction information for a funds transfer may include, but is not limited to, a unique identifier associated with the fund transfer transaction, a timestamp of the transaction, and transaction parameter information (e.g., a source account, a target account, a transaction date, and an amount of transfer).

In certain embodiments, the data record within transaction data 144C may also include an identifier indicative of a status of the initiated funds transfer transaction. For instance, the online banking portal may enable the customer to initiate the funds transfer transaction, and to provide transaction parameter information used to successfully execute the funds transfer transaction (e.g., information identifying a source account, a target account, a transaction date, and an amount of transfer).

For example, upon specification of the transaction parameter information, financial transaction server 142 may assign a status of “In Progress” to the initiated transaction, and may store a corresponding identifier of the status within the data record. Further, upon successful execution of the initiated transaction, financial transaction server 142 may update the status identifier stored within the data record to reflect the completed execution. Additionally or alternatively, upon cancellation of the initiated transaction (e.g., based on a customer request or upon expiration of a time-out period), financial transaction server 142 may update the status identifier stored within the data record to reflect the cancellation of the initiated transaction

In further embodiments, the initiated funds transfer transaction may be “interrupted” prior to execution by financial transaction server 142. For example, a loss of communication or a technical glitch might prevent the customer from completely specifying the transaction parameter information used to execute the transaction, and after expiration of a predetermined time period (e.g., fifteen minutes), financial transaction server 142 may then deem the transaction “interrupted.” Additionally or alternatively, financial transaction server 142 may determine that an initiated funds transfer transaction is “interrupted” when financial transaction server 142 fails to execute the transaction within the predetermined time period. Financial transaction server 142 may, in certain embodiments, assign a status of “interrupted” to the initiated funds transfer transaction and may update the status identifier stored within the data record to reflect the interrupted state. Further, in some instances, transaction server 142 may also store, in the data record, information associated with the interrupted state, which includes, but is not limited to, a time at which transaction server 142 identified the interruption.

Merchant system 150 may be one or more computer systems associated with a business entity that provides products and/or services. In one example, merchant system 150 may be associated with a retailer having one or more physical retail locations disposed within a geographic area (i.e., a “physical retailer”). Merchant system 150 may be a retailer that provides electronic or e-commerce type retail services. In one example, merchant system 150 may be an electronic or an e-commerce retailer that interacts with consumers through corresponding web interfaces or retailer-specific application programs (e.g., mobile “apps”). In one embodiment, one or more client devices 102, 104, and 106 can exchange information with merchant system 150 to purchase one or more goods and/or services using various payment instruments, and merchant system 150 exchanges information with financial transaction system 140 to obtain authorization for such purchase instruments, e.g., using a point-of-sale module described below.

Merchant system 150 may include, in one example, a merchant server 152, a data repository 154, and point-of-sale (POS) module 156. Although not depicted in FIG. 1, merchant server 152 may include a front end and a back end disposed in communication with the front end. In an embodiment, the front and back ends may be incorporated into a hardware unit, for example, a single computer, a single server, or any additional or alternate computing device apparent to one or skill in the art. In other embodiments, the front end may be a software application, such as a web service, executing on merchant server 152. However, merchant server 152 is not limited to such configurations, and, in additional embodiments, the front end may be executed on any computer or server separate from the back end.

Data repository 154 may be one or more storage devices that store information consistent with the disclosed embodiments. In one aspect, data repository 154 may store customer data that uniquely identifies and profiles one or more customers of the merchant associated with merchant system 150, and transaction data identifying one or more purchase transactions involving one or more customers of the merchant. Further, in such embodiments, data repository 164 also includes elements of electronic content that may be delivered to customers of the merchant, including but not limited to, images and corresponding text describing goods and services sold by the merchant, one or more advertisements that could be delivered to the customers, and one or more rewards that could be provided to the customer.

In one embodiment, POS 156 may be one or more point-of-sale devices configured to perform known point-of-sale processes. A POS 156 may be disposed at a physical location in a merchant location associated with merchant system 150, such as a location where a customer may provide payment for goods and/or services (e.g., at a cash register at the merchant). The disclosed embodiments are not limited to such physical POS modules, and in additional embodiments, POS module 156 may be a software module executed by merchant server 152.

Client devices 102, 104, and 106 may each reflect a computing device associated with a user (e.g., a customer of the merchant and/or the financial institution disclosed above). In certain aspects, client devices 102, 104, and 106 can include, but are not limited to, a personal computer, a laptop computer, a tablet computer, a notebook computer, a hand-held computer, a personal digital assistant, a portable navigation device, a mobile phone, a smart phone, a set top box, a third party portals, an optical disk player (e.g., a DVD player), a digital video recorder (DVR), and any additional or alternate computing device operable to transmit and receive data across network 120.

Further, although computing environment 100 is illustrated in FIG. 1 with three client devices 102, 104, and 106 in communication with transaction system 140, persons of ordinary skill in the art will recognize that environment 100 may include any number of number of mobile or stationary client devices, and any additional number of computers, systems, or servers without departing from the spirit or scope of the disclosed embodiments. Further, although computing environment 100 is illustrated in FIG. 1 with a single merchant system 150, a single transaction system 140, a single server 160, and a single external data repository 170, persons of ordinary skill in the art will recognize that environment 100 may include any number of additional number of merchant and financial systems, any number of additional number of servers and data repositories, and any additional number of computers, systems, servers, or server farms without departing from the spirit or scope of the disclosed embodiments.

Communications network 120 may represent any form or medium of digital data communication. Examples of communication network 120 include a local area network (“LAN”), a wireless LAN, a RF network, a Near Field Communication network, e.g., a “WiFi” network, a wireless Metropolitan Area Network (MAN) that connects multiple wireless LANs, and a wide area network (“WAN”), e.g., the Internet. Consistent with embodiments of the present disclosure, network 120 can include the Internet and include any publicly accessible network or networks interconnected via one or more communication protocols, including, but not limited to, hypertext transfer protocol (HTTP) and transmission control protocol/internet protocol (TCP/IP). Moreover, communications network 120 may also include one or more mobile device networks, such as a GSM network or a PCS network, that allow client devices, such as client device 102, to send and receive data via applicable communications protocols, including those described above.

In one embodiment, one or more of transaction server 142 and merchant server 152 may include a general purpose computer (e.g., a personal computer, network computer, server, or mainframe computer) having one or more processors that may be selectively activated or reconfigured by a computer program. In additional embodiments, one or more of transaction server 142 and merchant server 152 may be incorporated as corresponding nodes in a distributed network, and additionally or alternatively, as corresponding networked servers in a cloud-computing environment. Furthermore, transaction server 142 and merchant server 152 may communicate via network 120 with one or more additional servers (not shown), which facilitate the distribution of processes for parallel execution by the additional servers. In certain aspects, transaction server 142 and/or merchant server 152 may execute software instructions that perform one or more processes consistent with the disclosed embodiments.

Server 160 may be a computing device that provides information to one or more other components of computing environment 100. In one embodiment, server 160 may include a general-purpose computer (e.g., a personal computer, network computer, server, or mainframe computer) having one or more processors that may be selectively activated or reconfigured by a computer program. In one aspect, server 160 may be configured to provide one or more websites associated with an advertiser and/or content provider network. Further, upon request from a client device (e.g., client device 102), server 160 may be configured to provide Information associated with a requested web page over communications network 120 to client device 102, which may render the received information and present the web page to a customer. Additionally, server 160 may be incorporated as a corresponding node in a distributed network, and additionally or alternatively, as a corresponding networked server in a cloud-computing environment. Furthermore, server 160 may communicate via network 120 with one or more additional servers (not shown), which may facilitate the distribution of processes for parallel execution by the additional servers.

Data repository 170 may be one or more storages that store information provided by or used by one or more components of computing environment 100. In one aspect, data repository may be incorporated into a single hardware unit, for example, a single computer or a single server. In such an embodiment, data repository 170 may include one or more storage mediums or storage devices. However, data repository 170 is not limited to such configurations, and, in additional embodiments, data repository 170 may reside on any additional or alternate computer or server accessible to transaction server 142, merchant server 152, and client devices 102, 104, and 106 over network 120.

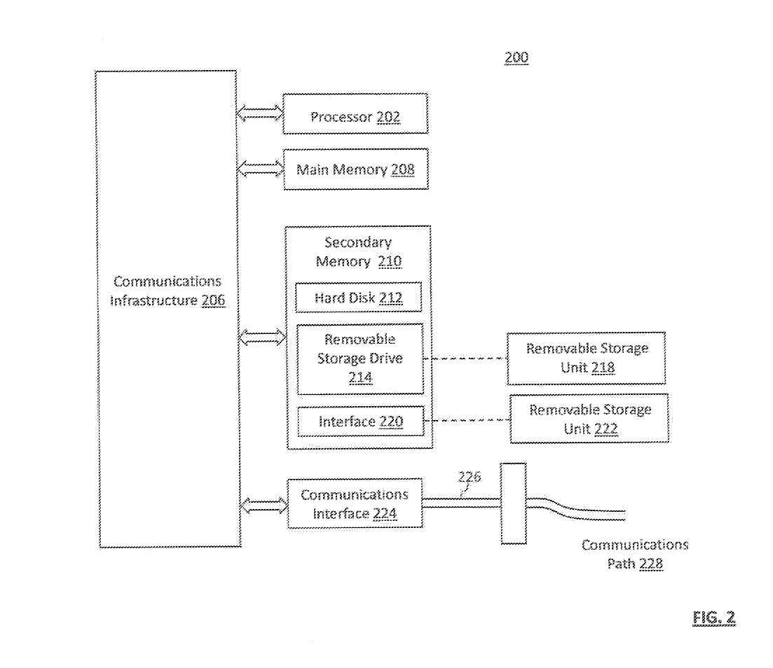

FIG. 2 is an exemplary computer system 200 with which embodiments consistent with the present disclosure may be implemented. In one aspect, computer system 200 may reflect the computer systems associated with server 142, server 152, server 160, client devices 102, 104, and/or 106. In certain embodiments, computer system 200 may include one or more processors, such as processor 202. Processor 202 may be connected to a communication infrastructure 206, such as a bus or communications network, e.g., network 120 of FIG. 1.

Computer system 200 may also include a main memory 208, for example, random access memory (RAM), and may include a secondary memory 210. Secondary memory 210 may include, for example, a hard disk drive 212 and/or a removable storage drive 214, representing a magnetic tape drive, an optical disk drive, CD/DVD drive, etc. The removable storage drive 214 reads from and/or writes to a removable storage unit 218 in a well-known manner. Removable storage unit 218 may represent a magnetic tape, optical disk, or other storage medium that is read by and written to by removable storage drive 214. As will be appreciated, the removable storage unit 218 can represent a computer-readable medium having stored therein computer programs, sets of instructions, code, or data to be executed by processor 202.

In alternate embodiments, secondary memory 210 may include other means for allowing computer programs or other program instructions to be loaded into computer system 200. Such means may include, for example, a removable storage unit 222 and an interface 220. An example of such means may include a removable memory chip (e.g., EPROM, RAM, ROM, DRAM, EEPROM, flash memory devices, or other volatile or non-volatile memory devices) and associated socket, or other removable storage units 222 and interfaces 220, which allow instructions and data to be transferred from the removable storage unit 222 to computer system 200.

Computer system 200 may also include one or more communications interfaces, such as communications interface 224. Communications interface 224 allows software and data to be transferred between computer system 200 and external devices. Examples of communications interface 224 may include a modem, a network interface (e.g., an Ethernet card), a communications port, a PCMCIA slot and card, etc. Software and data may be transferred via communications interface 224 in the form of signals 226, which may be electronic, electromagnetic, optical or other signals capable of being received by communications interface 224. These signals 226 are provided to communications interface 224 via a communications path (i.e., channel 228). Channel 228 carries signals 226 and may be implemented using wire, cable, fiber optics, RF link, and/or other communications channels. In a disclosed embodiment, signals 226 comprise data packets sent to processor 202. Information representing processed packets can also be sent in the form of signals 226 from processor 202 through communications path 228.

In certain embodiments in connection with FIG. 2, the terms “storage device” and “storage medium” may refer to particular devices including, but not limited to, main memory 208, secondary memory 210, a hard disk installed in hard disk drive 212, and removable storage units 218 and 222. Further, the term “computer-readable medium” may refer to devices including, but not limited to, a hard disk installed in hard disk drive 212, any combination of main memory 208 and secondary memory 210, and removable storage units 218 and 222, which respectively provide computer programs and/or sets of instructions to processor 202 of computer system 200. Such computer programs and sets of instructions can be stored within one or more computer-readable media. Additionally or alternatively, computer programs and sets of instructions may also be received via communications Interface 224 and stored on the one or more computer-readable media.

Such computer programs and instructions, when executed by processor 202, enable processor 202 to perform one or more processes consistent with the disclosed embodiments. Examples of program instructions include, for example, machine code, such as code produced by a compiler, and files containing a high-level code that can be executed by processor 202 using an interpreter.

Furthermore, the computer-implemented methods described herein can be implemented on a single processor of a computer system, such as processor 202 of system 200. However, in additional embodiments, these computer-implemented methods may be implemented using one or more processors within a single computer system, and additionally or alternatively, these computer-implemented methods may be implemented on one or more processors within separate computer systems linked via a network.

In one embodiment, a customer at a client device (e.g., one of client devices 102, 104, and 106 of FIG. 1) may access an online banking portal associated with a system of a financial institution (e.g., financial transaction system 140 of FIG. 1). For instance, using the online banking portal, the customer may request an electronic funds transfer (EFT) transaction between accounts held at the financial institution, and may subsequently specify transaction parameter information (e.g., a source account, a target account, a transaction date, and an amount of transfer) that enables the execution of the EFT transaction by financial transaction system 140.

During or subsequent to the customer's specification of the transaction parameter information, the execution of the requested EFT transaction may be interrupted by, among other things, a loss of connectivity, a power failure, a system failure, human error, or force majeure. In such an instance, financial transaction system 140 may provide the customer with messages that alert the customer to the interruption and enable the customer to complete the execution of the requested transaction without submitting additional authentication credentials.

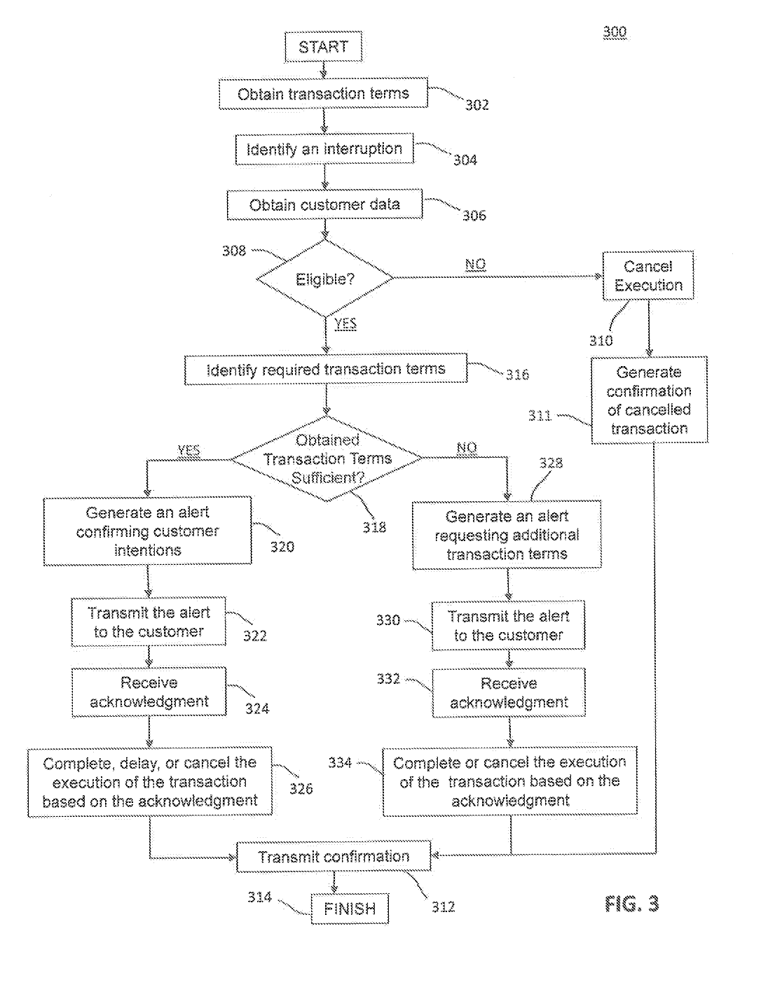

FIG. 3 illustrates an exemplary method 300 for completing interrupted transactions, in accordance with disclosed embodiments. In one embodiment, a server (or other computing device or system) associated with a financial institution (e.g., transaction server 142 of FIG. 1) may be configured to identify an interruption in an execution of a transaction requested by a user at a client device (e.g., client device 102), to determine whether received transaction terms are sufficient to complete the execution of the transaction, and to provide the customer with options to complete the execution of the transaction based on the sufficiency of the received transaction terms.

In this exemplary embodiment, method 300 is described with respect to a transaction that includes an electronic funds transfer (EFT) transaction between a customer's accounts at the financial institution (e.g., a transfer of funds from a savings account to a revolving line of credit). It will be appreciated, however, that the disclosed embodiments are not limited to EFT transactions, and that the exemplary techniques of FIG. 3 can be adapted for any additional or alternate financial transaction, which includes, but is not limited to, a payment of a bill, a purchase or sale of a financial instrument or security, a deposit or withdrawal of funds from accounts at the financial institution, or an application for credit from the financial institution.

In FIG. 3, in step 302, transaction server 142 may obtain information identifying values of one or more parameters of a transaction (i.e., “first transaction terms”). For example, the transaction may represent the electronic funds transfer (EFT) between the customer's accounts at the financial institution, and transaction server 142 may obtain the terms from a request from client device 102 to execute the EFT.

For instance, the disclosed embodiments may allow a customer to input one or more transaction terms into a web page associated with the financial institution (or alternatively, a graphical user interface (GUI) presented by a banking application). In such an embodiment, client device 102 may process the entered term(s) and generate a corresponding request to execute the EFT transaction, which may be transmitted by transaction server 142 across network 120 using any of the communications protocols outlined above.

In one embodiment, the transaction may be associated with one or more required transaction terms. For example, an EFT transaction can be executed in accordance with values of four required transaction terms, which include (i) an amount to transfer between accounts, (ii) a source account from which funds will be transferred, (iii) a target account into which funds will be transferred, and (iv) a date on which the transfer will occur. In one embodiment, a required transaction term may be a transaction term that the disclosed embodiments need to execute a transaction. However, the disclosed embodiments are not limited to required transaction terms. In other aspects, the disclosed embodiments may be configured to perform the disclosed processes based on one or more transaction terms (e.g., “second transaction terms”) that may be used to execute a transaction.

Referring back to the EFT transaction example above, transaction server 142 may be configured to obtain values for the exemplary four required transaction terms from the customer via client device 102. Alternatively, transaction server 142 may be configured to obtain values for the exemplary four required transaction terms by accessing customer data (e.g., information indicating the customer's election to complete all EFT transaction upon request) or by accessing prior transaction data (e.g., the customer requested completion of all EFT transaction two days after request).

Referring back to FIG. 3, transaction server 142 identifies an interruption in an execution of the requested transaction in step 304. In one embodiment, transaction server 142 identifies the interruption based on a loss of communications between client device 102 and transaction server 142, and additionally or alternatively, a loss of communications between transaction server 142 and one or more components of financial transaction system 140. The disclosed embodiments are not limited such exemplary interruptions, and in additional embodiments, transaction server 142 may deem the execution of a transaction as interrupted when transaction server 142 fails to complete the transaction within a threshold time period (e.g., the execution of the transaction has “timed out.”).

In some embodiments, the identified interruption may result from a loss of power at client device 102 or transaction server 142, a system failure at client device 102 or transaction server 142, human error, a failure of a component of financial transaction system 140, force majeure, or any other type of interruption, such as a combination thereof. Further, by way of example, the interruption may occur during the customer's specification of values for the corresponding transaction terms at client device 102 (e.g., through a web page or GUI associated with an executable application), or alternatively, after receipt of the of the transaction term values from client device 102 (e.g., during internal processing by transaction server 142 to execute the transaction).

As described herein, transaction server 142 can, upon identification of an interruption, provide the customer with opportunities to complete the execution of the interrupted transaction without submitting additional authentication credentials or specifying additional values for the transaction terms of the interrupted transaction (e.g., though corresponding “transaction completion alerts”). In one embodiment, prior to providing such opportunities to the customer, transaction server 142 first determines whether the customer previously indicated a desire to receive such transaction completion alerts for the interrupted transaction (e.g., the customer has “opted-in”).

Referring back to FIG. 3, and upon identification of the interruption in step 304, transaction server 142 may obtain profile data associated with the customer in step 306, and determines in step 308 whether the customer is eligible to receive transaction completion alerts for the interrupted transaction. For example, transaction server 142 may access a corresponding data repository (e.g., customer data 144C of data repository 144, or alternatively, external data repository 170) to obtain the customer profile data, which the customer may have provided to transaction server 142 during a registration required to access one or more electronic banking features supported by transaction server 142.

Further, in some embodiments, the customer profile data can specify not only whether the customer desires to receive transaction completion alerts for interrupted transactions, but can also identify specific accounts or specific types of transactions subject to automated completion. For example, based on the customer profile data, transaction server 142 may determine that the customer elects to receive transaction completion alerts for all interrupted transactions, no interrupted transactions, or only particular interrupted transactions (e.g., EFT transactions).

Further, if transaction server 142 determines that the customer elects to receive a transaction completion alert for the interrupted transaction, transaction server 142 may determine whether a timeliness of the interrupted transaction renders the interrupted transaction eligible for transaction completion alerts. For instance, in step 308, transaction server 142 may identify a time associated with the interrupted transaction, and determine the interrupted transaction eligible for transaction completion alerts when the identified time falls within a threshold time period of the current time. By way of example, the predetermine time period may include, but is not limited to, one hour, twelve hours, twenty-four hours, and one business day.

Referring back to FIG. 3, if transaction server 142 determines that the customer or the interrupted transaction (e.g., the EFT transaction) is ineligible for transaction completion alerts (step 308; No), then transaction server 142 may cancel the execution of the interrupted transaction in step 310. Transaction server 142 then generates a confirmation of the cancelled transaction in step 311, and transmits the confirmation to client device 102 in step 312. For example, transaction server 142 may transmit the confirmation to client device 102 across network 120 using any of the communications protocols outlined above. Exemplary method 300 is then complete in step 314.

Alternatively, if transaction server 142 determines that the customer and the interrupted transaction are eligible for transaction completion alerts (step 308; Yes), transaction server may identify in step 316 one or more required transaction terms for the interrupted transaction. By example, and as described herein, the required transaction terms for an interrupted transaction may depend on a transaction type, and in some embodiments, transaction server 142 may obtain a transaction type associated with the interrupted transaction in step 316 (e.g., from transaction data 144C of FIG. 1), and determine the required transaction terms based on the identified transaction type.

For example, the customer may request an EFT transaction involving the customer's accounts at the financial institution. If transaction server 142 determines that the customer and the interrupted EFT transaction are eligible for transaction completion alerts, then transaction server 142 may identify one or more required transaction terms associated with the EFT transaction. For example, in step 316, transaction server 142 may determine that (i) an amount of the requested transfer, (ii) a source account from which the amount will be transferred, (iii) a target account to which the funds will be transferred, and (iv) a date on which the transfer will occur represent the required transaction terms for the EFT transaction.

In step 318, transaction server 142 may determine whether the obtained transaction terms (e.g., those obtained in step 302 above) include at least a threshold number of the required transaction terms (e.g., as identified by transaction server 142 in step 316). In an embodiment, the threshold number represents a minimum number of the required transaction terms that are essential to executing the interrupted transaction. For example, in an EFT transaction, an amount of the requested transfer, a source account, and a target account represent the threshold number of required transaction parameters, since the customer's specification of these three terms is required to execute the EFT transaction. In such embodiments, transaction server 142 may obtain a date of transfer from corresponding customer data (e.g., information Indicating the customer's election to complete all EFT transaction upon request) or through prior transaction data (e.g., the customer requested completion of all EFT transaction two days after request).

If transaction server 142 determines that the obtained terms include at least the threshold number of required transaction terms (step 318; Yes), then transaction server 142 generates an alert to the customer in step 320, and transmits the generated alert to client device 102 in step 322 across network 120 using any of the communications protocols outlined above.

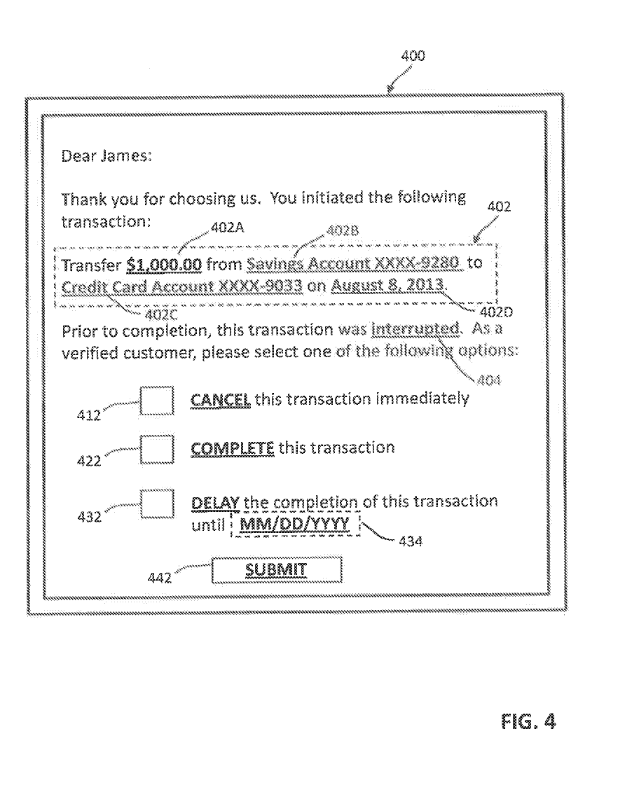

In one embodiment, the alert generated by transaction server 142 may include information that identifies the interrupted transaction and may also request confirmation of the customer's intention to, for example, complete the execution of the interrupted transaction in accordance with the obtained transaction terms, to cancel execution of the interrupted transaction, or to delay the execution of the in accordance with a predetermined schedule or a customer-specified delay. Upon receipt of the alert, client device 102 may execute software processes to render and display the received alert to the user within a corresponding interface, as described below in reference to FIG. 4.

FIG. 4 illustrates an exemplary transaction completion alert 400, in accordance with disclosed embodiments. In such embodiments, a client device associated with the customer (e.g., client device 102 of FIG. 1) may receive information associated with transaction completion alert 400 from a server (or other computing device or system) associated with a financial institution (e.g., transaction server 142 of FIG. 1) across network 120. Client device 102 may execute software processes to render the received information and display alert 400 to the customer within a corresponding display. For example, the disclosed embodiments may execute software instructions that generate and display alert 400 within a portion of a web page associated with the financial institution (e.g., as accessed by the customer using a link delivered to the customer in an email message, text message, or instant message). In another aspects, the disclosed embodiments may execute software instructions that generate and display alert 400 within a graphical user interface (GUI) of an application associated with the financial institution and executed by client device 102 (e.g., mobile banking application executed on a smartphone).

In FIG. 4, alert 400 includes information 402 identifying one or more transaction terms provided by the customer when requesting execution of a corresponding transaction (e.g., as received by transaction server 142 in step 302 of FIG. 3). For example, information 402 in FIG. 4 may identify that the customer requested a “Transfer” of a specified amount 402A (i.e., $1,000) from a source account 402B (i.e., “Savings Account XXXX-9280”) to a target account 402C (i.e., “Credit Card Account XXXX-9033”) on a transfer date 402D (e.g., “Aug. 8, 2013”). The disclosed embodiments are, however, not limited to such exemplary transaction types and corresponding transaction terms. In additional embodiments, alert 400 may identify any additional or alternate transaction type requested by the customer and appropriate to the financial institution, and any additional or alternate transaction terms appropriate to the identified transaction type, without departing from the spirit or scope of the disclosed embodiments.

Alert 400 may also specify that an execution of the requested transaction was interrupted prior to completion, such as in region 404. In one aspect, alert 400 may present to the customer one or more options to cancel the transaction, complete the execution or the transaction, and delay the execution of the transaction. For example, by selecting region 412 of alert 400 (e.g., by clicking on region 412, tapping region 412 with a finger or stylus, or through an entry of appropriate keystrokes), the customer may indicate an intention to cancel the execution of the transfer transaction. Alternatively, the customer may indicate an intention to complete the execution of the requested transfer transaction in accordance with transaction terms displayed in region 422.

Further, in an embodiment, the customer may intend to complete the execution of the transaction, but not on the specified transfer date 402D (i.e., Aug. 8, 2013). In such an embodiment, the customer may select region 432 of alert 400 to indicate an intention to delay execution of the transfer transaction until a future date specified by the customer in region 434. The disclosed embodiments are not limited to transaction delays specified by the customer in alert 400, and in further embodiments, alert 400 may enable the customer to indicate an intention to delay execution of the requested transaction by a predetermined time period, or by any additional or alternate time period appropriate to the financial institution and the requested transaction.

Once the customer indicates an intention regarding the interrupted transaction by selecting one of regions 412, 422, and 432, the customer may then select region 442 to submit the indicated intention to transaction server 142. In one embodiment, upon selecting region 442, client device 102 may generate an acknowledgment in response to alert 400 that includes indication the customer's intention regarding the interrupted transaction, and may transmit the acknowledgment across network 120 to transaction server 142 using any of the communications protocols outlined above.

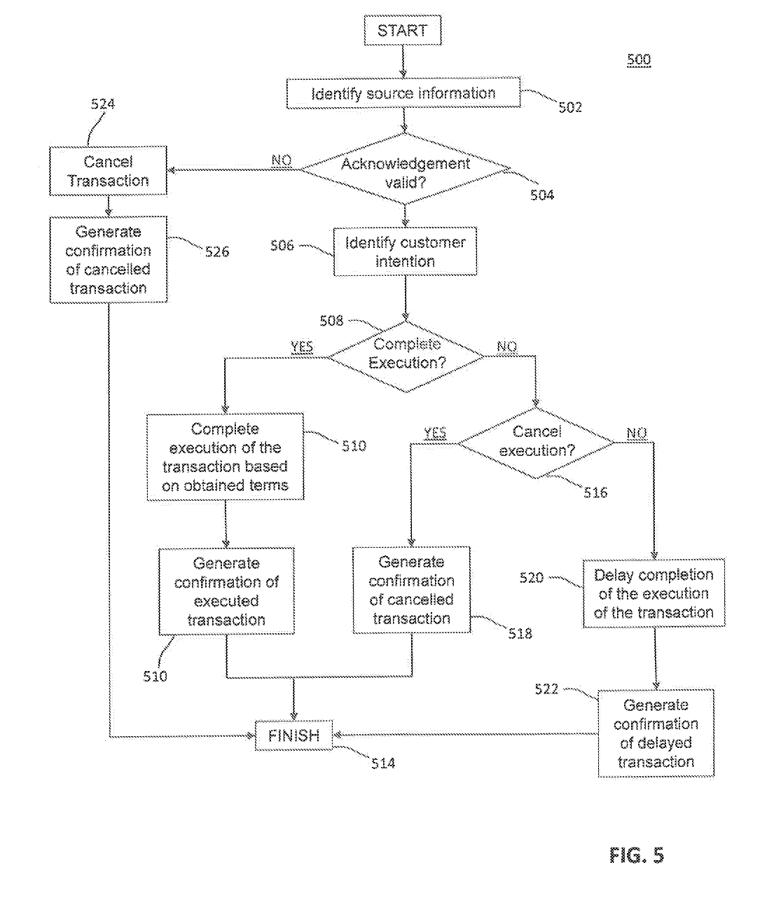

Referring back to FIG. 3, in step 324, transaction server 142 may receive the acknowledgment in response to the transmitted alert, and in step 326, transaction server 142 processes the message to identify and act in accordance with an intention of the customer with respect to the interrupted transaction. For example, in step 326, transaction server 142 may be configured to execute software instructions to validate the received acknowledgment message. Based on the analysis transaction server 142 may cancel the execution of the transaction, complete the execution of the transaction in accordance with the obtained terms, or delay the execution of the transaction for a predetermined time period or a customer-specified time period, as described below in reference to FIG. 5.

FIG. 5 is a flow diagram of an exemplary method 500 for cancelling, completing, or delaying an interrupted transaction, according to a disclosed embodiment. In one embodiment, a server (or other computing device or system) associated with a financial institution (e.g., transaction server 142 of FIG. 1) may be configured to identify a customer's intention regarding an interrupted transaction, and to either cancel, complete, or delay the execution of the interrupted transaction in accordance with the customer's intention. For example, method 500 may be may be incorporated into step 326 of FIG. 3 to cancel, complete, or delay an execution of an interrupted transaction based on a customer's acknowledgment of a transmitted alert.

In FIG. 5, transaction server 142 receives and processes an acknowledgment message in step 502 to obtain information identifying a source of the message (e.g., a telephone number or a corresponding IP address). In step 504, transaction server 142 may compare the obtained source information with the preferred mode or modes of contact associated with the customer to validate the acknowledgment message.

For example, in step 504, transaction server 142 may obtain profile data associated with a customer (e.g., from customer data 144A of data repository 144 or external data repository 170 of FIG. 1) to obtain the customer's preferred mode or modes of contact. As described herein, the preferred mode of contact can specify a mobile telephone number associated with client device 102, and additionally or alternatively, may identify an Internet Protocol (IP) address associated with client device 102.

In certain embodiments, transaction server 142 may provide transaction completion alerts to the customer in accordance with the preferred mode or modes of contact, and may confirm the validity of the received acknowledgment message when that message is received in accordance with the preferred mode or modes of contact. For example, if a customer's preferred mode of contact includes an IP address of client device 102, and if transaction server receives the acknowledgment message from a device having an IP address that matches the IP address of client device 102, transaction server 142 may validate the acknowledgment message in step 504.

If transaction server 142 determines that the acknowledgement message is valid (step 504; Yes), transaction server 142 may process the received acknowledgment message to identify the customer's intention regarding the interrupted transaction in step 506. For example, the acknowledgment message may include information identifying the customer's intention to complete an execution of the transaction in accordance with one or more obtained transaction terms, to delay the completion of the execution for a customer-specified or predetermined time period, or to cancel the transaction.

In step 508, transaction server 142 may determine whether the customer intends to complete the execution of the transaction in accordance with the obtained transaction terms. If transaction server 142 determines that the customer intends completion (step 508; Yes), then transaction server 142 may complete the requested transaction in accordance with the transaction terms provided by the customer (e.g., as obtained in step 302 of FIG. 3). For example, in reference to the exemplary alert of FIG. 4, transaction server 142 can complete, in step 510, a transfer of $1,000 from a customer's savings account (e.g., Savings Account XXXX-9280) to the customer's credit card account (e.g., Credit Card Account XXXX-9033) on Aug. 8, 2013. Upon completion of the requested transaction in step 510, transaction server 142 generates a confirmation of the executed transaction, updates transaction and account data associated with the customer (e.g., account data 144B and transaction data 144C of FIG. 1), and method 500 is complete in step 514.

Alternatively, if transaction server 142 determines that the customer intends does not intend to complete the interrupted transaction in accordance with the obtained terms (step 508; No), transaction server 142 may determine in step 516 whether the customer intends to cancel the execution of the transaction. If transaction server 142 determines that the customer intends cancellation (step 516; Yes), then transaction server 142 may cancel the transaction, generates a confirmation of the cancelled transaction in step 518, and updates transaction and account data associated with the customer (e.g., account data 144B and transaction data 144C of FIG. 1. As described herein, method 500 may complete in step 514.

If, however, transaction server 142 determines that the customer does not intend to cancel the interrupted transaction (step 516; No), then in step 520, transaction server 142 may be configured to delay the execution of the interrupted transaction in accordance with a customer-specified time period included within the acknowledgment message, or alternatively, in accordance with a predetermined delay. In some embodiments, the execution of the interrupted transaction may be completed in accordance with the obtained transaction terms (e.g., those identified in region 402 of alert 400 in FIG. 1), but at a later time. Transaction server 142 then generates a confirmation of the delayed execution in step 522 and updates transaction and account data associated with the customer (e.g., account data 144B and transaction data 144C of FIG. 1). Method 500 is complete in step 514.

Referring back to step 504, transaction server 142 may fail to validate the received acknowledgment message. For example, the source information associated with the received acknowledgment message may not match any of the preferred contact information associated with the customer. In such an embodiment, transaction server 142 may cancel the interrupted transaction in step 524, update corresponding transaction and account data, and generate a corresponding confirmation message in step 526. For example, the confirmation message generated by transaction server 142 in step 526 may request that the user provide authentication credentials to submit an additional request for the now-cancelled transaction, and such authentication credential may include, but are not limited to, a user name, an email address, a password, and the answer to a customer-specified security question. Exemplary method 500 is then complete in step 514.

Referring back to FIG. 3, and in accordance with the customer's intention expressed in the received acknowledgment message, transaction server 142 may either cancel the execution of the transaction, complete the execution of the transaction in accordance with the obtained terms, or delay the execution of the transaction for a predetermined time period or a customer-specified time period in step 326. Additionally or alternatively, transaction server 142 may execute software processes to automatically cancel the execution of the transaction if transaction server 142 fails to receive the acknowledgment message within a predetermined time period (e.g., five minutes, fifteen minutes, or thirty minutes). Further, as described herein, transaction server 142 may also generate a message in step 326 confirming the completion, cancellation, or delay of the execution of the interrupted transaction, which may be transmitted the confirmation to client device 102 in step 312. For example, transaction server 142 may transmit the conformation to client device 102 across network 120 using any of the communications protocols outlined above. Exemplary method 300 is then complete in step 314.

If, however, transaction server 142 determines that the obtained terms fail to include at least the threshold number of the required transaction terms (step 318; No), then transaction server 142 may generate a message in step 328 that alerts the customer to the deficiency in the required transaction terms. For example, the customer may wish to execute a transfer of funds from a savings account to credit card account on a specific date, but may have only specified an amount of the requested transfer (e.g., $1,000.00) and a source account associated with the requested transfer (e.g., “Savings Account XXXX-9280”) before a loss of connectivity between client device 102 and transaction server 142 occurs.

In such an instance, transaction server 142 may determine in step 318 that the obtained transaction terms fail to include an identifier of a target account to which the specified funds will be transferred, and as such, fail to include the threshold number of required transaction terms for the EFT transaction. Transaction server 142 may generate a transaction completion alert in step 328 that alerts the customer to the deficiencies in the obtained transaction terms and enables the customer to correct the deficiencies. In step 330, transaction server 142 may transmit the alert to client device 102 across network 120 using any of the communications protocols outlined above.

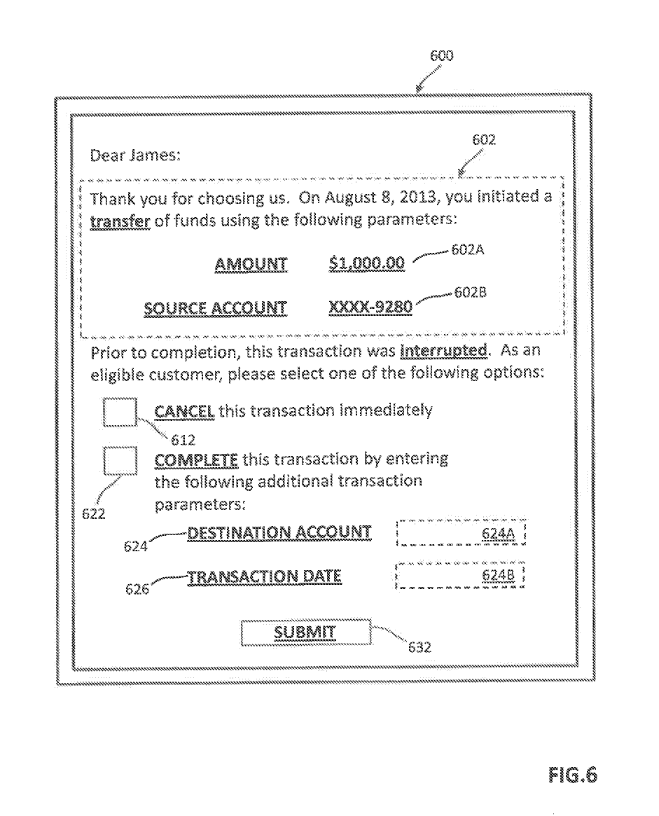

In one embodiment, the alert generated by transaction server 142 may include information that identifies the interrupted transaction and the obtained transaction terms, and requests confirmation the customer's intention to provide additional transaction terms that facilitate a completion of the interrupted transaction, or alternatively, to cancel the interrupted transaction. Upon receipt of the alert, client device 102 may render the received alert and display the received alert to the customer within a corresponding interface, as described below in reference to FIG. 6.

FIG. 6 illustrates an exemplary automatic completion alert 600, in accordance with disclosed embodiments. In such embodiments, a client device associated with the customer (e.g., client device 102 of FIG. 1) may receive information associated with transaction completion alert 600 from a server (or other computing device or system) associated with a financial institution (e.g., transaction server 142 of FIG. 1) across network 120, and may then render the received information and display alert 600 to the customer within a corresponding display. For example, alert 600 may be presented within a portion of a web page associated with the financial institution (e.g., as accessed by the customer using a link delivered to the customer in an email message, text message, or instant message), or alternatively, alert 600 may be displayed within a graphical user interface (GUI) of an application associated with the financial institution and executed by client device 102 (e.g., mobile banking application executed on a smartphone).

In FIG. 6, alert 600 may include information 602 that identifies the requested transaction and one or more transaction terms provided by the customer when requesting execution of the transaction (e.g., as received by transaction server 142 in step 302 of FIG. 3). For example, information 602 in FIG. 6 identifies that the customer requested a transfer of a specified amount 602A (i.e., $1,000) from a source account 602B (i.e., “Savings Account XXXX-9280”). The disclosed embodiments are, however, not limited to such exemplary transaction types and corresponding transaction terms. In other embodiments, alert 400 may identify any additional or alternate transaction type requested by the customer and appropriate to the financial institution, and any additional or alternate transaction terms appropriate to the identified transaction type, without departing from the spirit or scope of the disclosed embodiments.

As exemplified above, however, the customer's entry of the transaction terms was interrupted prior to completion (e.g., due to a loss of communication between client device 102 and transaction server 142, a power failure, a system failure, a force majeure, etc.). The disclosed embodiments may generate and provide alert 600 that may indicate the identified interruption to the customer in region 604. In such an example, alert 600 may include information that presents to the customer one or more options to cancel the transaction immediately, or alternatively, supply the additional transaction terms required to complete the requested funds transfer.

For example, in FIG. 6, the customer may select region 612 (e.g., by clicking on region 612, tapping region 612 with a finger or stylus, or through an entry of appropriate keystrokes) to indicate an intention to immediately cancel the execution of the transfer transaction. Alternatively, the customer may intend to complete the execution of the requested funds transfer, and may select region 622 (e.g., by clicking on region 622, tapping region 622 with a finger or stylus, or through an entry of appropriate keystrokes) to indicate an intention to provide the transaction terms necessary to complete the execution of the transaction.

In such embodiments, the customer may enter the necessary transaction terms, which include destination account 624 and transfer date 626, within corresponding ones of regions 624A and 626A. For example, the user may enter a credit card account (e.g., “Credit Card Account XXXX-9033”) within region 624A to specify the credit card account as the recipient of funds from the savings account, and may enter a specific date (e.g., “Aug. 23, 2013”) on which the transfer will occur within region 626A.

Upon selection of one of regions 612 and 622, and additionally or alternatively, entered values for transaction terms 624 and 626 within regions 624A and 626A, the customer may then select region 632 to submit the customer's intention to transaction server 142. In such an embodiment, upon selecting region 632, client device 102 generates an acknowledgment to alert 600 that includes indication the customer's intention regarding the interrupted transaction, and subsequently transmits the acknowledgment across network 120 to transaction server 142 using any of the communications protocols outlined above.

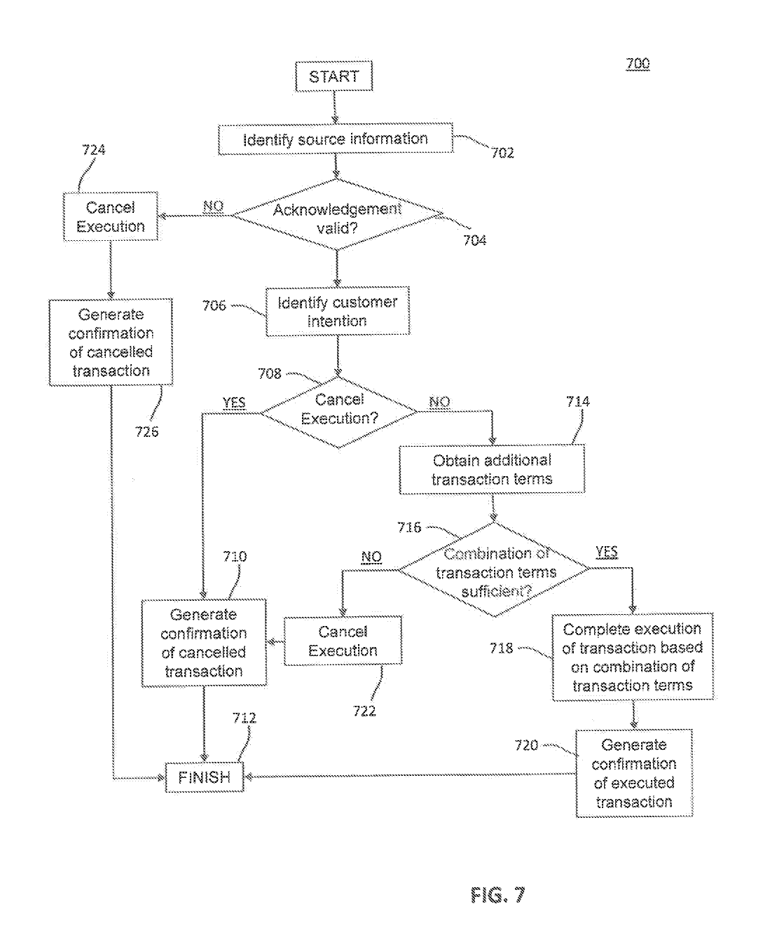

Referring back to FIG. 3, in step 332, transaction server 142 receives the acknowledgment in response to the alert transmitted in step 330, and in step 334, transaction server 142 subsequently processes the acknowledgment message to identify and act in accordance with an intention of the user with respect to the interrupted transaction. For example, in step 334, transaction server 142 may execute software instructions to validate the received acknowledgment message, and either cancel the execution of the transaction or complete the execution of the transaction in accordance with the obtained transaction terms and the additional terms provided by the user and included within the acknowledgment, as described below in reference to FIG. 7.

FIG. 7 is a flow diagram of an exemplary method 700 for cancelling or completing an interrupted transaction, according to a disclosed embodiment. In one embodiment, a server (or other computing device or system) associated with a financial Institution (e.g., transaction server 142 of FIG. 1) may be configured to identify a customer's intention regarding an interrupted transaction, and to either cancel or complete the execution of the interrupted transaction in accordance with the customer's intention. For example, method 700 may be may be incorporated into step 334 of FIG. 3 to cancel or complete an execution of an interrupted transaction based on a customer's acknowledgment of a transmitted alert.

In FIG. 7, transaction server 142 may receive and process an acknowledgment message in step 702 to obtain information identifying a source of the message (e.g., a telephone number or a corresponding IP address). In step 704, transaction server 142 may compare the obtained source information with the preferred mode or modes of contact associated with the customer to validate the acknowledgment message.

For example, in step 704, transaction server 142 may obtain profile data associated with a customer (e.g., from customer data 144A of data repository 144 or external data repository 170 of FIG. 1) to obtain the customer's preferred mode or modes of contact. As described herein, the preferred mode of contact can specify a mobile telephone number associated with client device 102, and additionally or alternatively, may identify an Internet Protocol (IP) address associated with client device 102.

In certain embodiments, transaction server 142 may provide transaction completion alerts to the customer in accordance with the preferred mode or modes of contact, and may confirm the validity of the received acknowledgment message when that message is received in accordance with the preferred mode or modes of contact. For example, if customer's preferred mode of contact includes an IP address of client device 102, and if transaction server receives the acknowledgment message from a device having an IP address that matches the IP address of client device 102, transaction server 142 validates the acknowledgment message in step 704.

If transaction server 142 determines that the acknowledgement message is valid (step 704; Yes), transaction server 142 may process the received acknowledgment message to identify the customer's intention regarding the interrupted transaction in step 706. For example, as described herein, the acknowledgment message may include information identifying the customer's intention to cancel the transaction, or alternatively, to complete an execution of the transaction in accordance with the previously obtained transaction terms and additional transaction terms specified in the acknowledgement message.

In step 708, transaction server 142 may determine whether the customer intends to cancel the execution of the interrupted transaction. If transaction server 142 determines that the customer intends cancellation (step 708; Yes), transaction server 142 may cancel the interrupted transaction, generates a confirmation of the cancelled transaction in step 710, and update transaction and account data associated with the customer (e.g., account data 144B and transaction data 144C of FIG. 1). Method 700 is complete in step 712.

Alternatively, if transaction server 142 determines that the customer does not intend to cancel the interrupted transaction (step 708; No), then transaction server 142 may parse the acknowledgement message in step 714 to obtain additional transaction terms provided by the customer. For example, in reference to alert 600 of FIG. 6, the customer may specify a destination account for an interrupted funds transfer (e.g., “Credit Card Account XXXX-9033”) and transfer date associated with the interrupted funds transfer (e.g., “Aug. 23, 2013”). In such embodiments, described above, a client device of the customer (e.g., client device 102 of FIG. 1) incorporates the specified transaction terms into the acknowledgment message, with information identifying the customer's intention to complete the interrupted transaction based on the specified transaction terms and the previously entered transaction terms.

Referring back to FIG. 7, transaction server 142 may determine in step 716 whether the previously obtained transaction terms (e.g., the transaction terms obtained in step 302 of FIG. 3) and those additional transaction terms obtained from the acknowledgment message are, when taken as whole, sufficient to complete the execution of the interrupted transaction. For example, as described herein, transaction server 142 may have previously obtained an amount associated with an interrupted EFT (e.g., $1,000.00) and a source account associated with the interrupted EFT (e.g., “Savings Account XXXX-9280”). Further, in step 714, transaction server 142 may obtain information identifying a target account for the interrupted EFT (e.g., “Credit Card Account XXXX-9033”) and transfer date associated with the interrupted EFT (e.g., “Aug. 23, 2013”). In such an embodiment, transaction server 142 may determine in step 716 that the combination of the previously obtained transaction terms and the additional transaction terms are sufficient to complete the interrupted EFT transaction.

If transaction server 142 determines that the combination of the previously obtained transaction terms and the additional transaction terms is sufficient to complete the execution of the interrupted transaction (step 716; Yes), transaction server 142 completes the execution of the interrupted transaction in step 718. For instance, transaction server 142 may complete the execution of the interrupted transaction in accordance with both the previously obtained transaction terms and those additional transaction terms obtained from the acknowledgement message. Upon completion of the interrupted transaction in step 718, transaction server 142 may generate a confirmation of the completed transaction in step 720, and updates transaction and account data associated with the customer (e.g., account data 144B and transaction data 144C of FIG. 1). Method 700 is then complete in step 712.

If, however, transaction server 142 determines that the combination of the previously obtained transaction terms and the additional transaction terms are still insufficient to complete the execution of the interrupted transfer (step 716; No), then transaction server 142 cancels the execution of the interrupted transaction in step 722. For example, the customer may have entered an insufficient, or alternatively, inaccurate values for the required transaction terms displayed in an alert message (e.g., alert 600 of FIG. 6), and transaction server 142 may determine that these insufficient or inaccurate transaction terms cannot form a basis for completed the interrupted transaction in step 716. Method 700 may proceed to step 710, and transaction server 142 may generate a confirmation of the cancelled transaction and updated corresponding transaction and account data, as described above.

Referring back to step 704, transaction server 142 may fail to authenticate the received acknowledgment message. For example, the source information associated with the received acknowledgment message may not match any of the preferred contact information associated with the customer. In such an embodiment, transaction server 142 may cancel the interrupted transaction in step 724, update corresponding transaction and account data, and generate a corresponding confirmation message in step 726. For example, the confirmation message generated by transaction server 142 in step 726 may request that the user provide authentication credentials to submit an additional request for the now-cancelled transaction, and such authentication credential may include, but are not limited to, a user name, an email address, a password, and the answer to a customer-specified security question. Exemplary method 700 is then complete in step 712.

Referring back to FIG. 3, and in accordance with the customer's intention expressed in the received acknowledgment message, transaction server 142 may, in step 334, either cancel the execution of the transaction, or alternatively, complete the execution of the transaction in accordance with the obtained transaction terms and one or more additional transaction terms specified in the acknowledgement message. Additionally or alternatively, transaction server 142 may execute software processes to automatically cancel the execution of the transaction if transaction server 142 fails to receive the acknowledgment message within a predetermined time period (e.g., five minutes, fifteen minutes, or thirty minutes). Further, as described above, transaction server 142 may generate a message in step 334 confirming the completion, cancellation, or delay of the execution of the interrupted transaction, which may be transmitted the confirmation to client device 102 in step 312. For example, transaction server 142 may transmit the confirmation to client device 102 across network 120 using any of the communications protocols outlined above. Exemplary method 300 is then complete in step 314.

In the embodiments described above, a transaction completion alert (e.g., one or more of alerts 400 and 600) confirms a customer's intention to complete an execution of an interrupted transaction (e.g., an electronic funds transfer (EFT) transaction). Transaction server 142 may complete the execution of the interrupted EFT transaction upon receiving an acknowledgement of the alert and ascertaining the customer's intention without requiring the customer to submit additional authentication credentials.

The disclosed embodiments are, however, not limited to such exemplary modes of completion. In further embodiments, transaction server 142 may access profile data associated with the customer (e.g., customer data 144A of FIG. 1), which may indicate that certain types of interrupted transactions (e.g., EFT transactions) may be automatically completed without requiring a customer alert or a corresponding acknowledgment. For example, in reference to FIG. 3, upon determining that the obtained transaction terms include at least the threshold number of required transaction terms, transaction server 142 may identify a type associated with the interrupted transaction. Transaction server 142 may also process customer profile data to determine whether the interrupted transaction type may be automatically completed, and automatically complete the execution of the interrupted transaction without altering the customer or waiting for an acknowledgment from the customer.

Further, in some embodiments, transaction server 142 may not receive an acknowledgement of the transaction completion alert (e.g., in steps 322 and/or 330 of FIG. 3) from the customer. For example, the customer may not receive the transaction completion (e.g., due to a loss of wireless or wired connectivity at client device 102), and additionally or alternatively, the customer may not notice or may choose to ignore a received transaction completion alert. In such instances, as described herein, transaction server 142 may execute software processes to automatically cancel the interrupted transaction if transaction server 142 fails to receive the customer's acknowledgment message within a predetermined time period. By way of example, predetermined time periods consistent with the disclosed embodiments include, but are not limited to, five minutes, fifteen minutes, thirty minutes, or any additional or alternate time period appropriate to the interrupted transaction and to transaction server 142.

The disclosed embodiments also include configurations where a server associated with a financial institution (e.g., transaction server 142 of FIG. 1) may identify one or more interrupted transactions, alert one or more eligible customers to the interrupted transaction(s), and complete one or more of the interrupted transactions based on acknowledgments from the customers. The disclosed embodiments are not limited to such servers, and in additional embodiments, the disclosed techniques may be performed by an additional or alternate server (e.g., merchant server 162 of FIG. 1) capable to initiating and executing financial transactions, either alone or in combination with transaction server 142. For example, exemplary financial transactions include, but are not limited to, purchases of goods and services using a credit account issued by a financial institution, purchases or goods and services using an electronic funds transfer with a financial institution, and a withdrawal of funds from an account at a financial institution using a point-of-sale module (e.g., POS 166 of FIG. 1).

Various embodiments have been described herein with reference to the accompanying drawings. It will, however, be evident that various modifications and changes may be made thereto, and additional embodiments may be implemented, without departing from the broader scope of the invention as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the invention being indicated by the following listing of exemplary claims.

What is claimed is:

1. A computer-implemented method, comprising:
obtaining, by one or more processors, one or more first terms of a transaction, the transaction having a set of second terms used to execute the transaction;
identifying, by the one or more processors, an interruption in an execution of the transaction;
determining, by the one or more processors, in response to the identified interruption, whether the first transaction terms include a predetermined subset of the second transaction terms; and
generating, by the one or more processors, one or more first electronic instructions to complete the execution of the transaction, when the first transaction terms include at least the predetermined subset of the second transaction terms.

2. The method of claim 1, wherein the obtaining comprises receiving a request from a user to execute the transaction, the request comprising the first transaction terms, and the transaction comprising at least one of a fund transfer, a bill payment, a purchase of a financial instrument, a sale of a financial instrument, a deposit of funds, a withdrawal of funds, or an application for credit.

3. The method of claim 2, further comprising:
determining whether the user is eligible to complete the transaction based on at least one of an identity of the user, an account of the user, or a type of the transaction; and
generating the one or more first electronic instructions to complete the execution of the transaction in accordance with the first transaction terms when:
the first transaction terms include the predetermined subset of the second transaction terms; and
the user is determined to be eligible.

4. The method of claim 1, further comprising:
obtaining a time corresponding to the identified interruption;
determining whether the obtained time occurs within a threshold time period of a current time; and
generating the one or more first electronic instructions to complete the execution of the transaction in accordance with the first transaction terms when:
the first transaction terms include the predetermined subset of the second transaction terms; and
the interruption time occurs within the threshold time period of the current time.

5. The method of claim 1, further comprising:
when the first transaction terms include the predetermined subset of the second transaction terms, generating one or more second electronic instructions to transmit, to a device of a user, a first message requesting a confirmation of an intention of the user to execute the transaction; and
receiving a first response to the first message, the first response comprising at least one of:
a first request to complete the execution of the transaction;
a second request to cancel the execution of the transaction; or
a third request to delay the execution of the transaction,
wherein:
when the first response comprises the first request, the method further comprises generating the one or more first electronic instructions to complete the execution of the transaction in accordance with the first transaction terms;
when the first response comprises the second request the method further comprises generating one or more third electronic instructions to cancel the execution the transaction; and
when the first response comprises the third request, the method further comprises generating one or more third electronic instructions to delay the execution the transaction for at least one of a predetermined time period or a time period specified in the third request.

6. The method of claim 1, further comprising:
when first transaction terms do not include the predetermined subset of the second transaction terms, generating one or more second electronic instructions to transmit, to a device of a user, a second message requesting at least one of the second transaction terms; and
receiving a second response to the second message.

7. The method of claim 6, wherein the second response comprises the at least one of the second transaction terms, and wherein the method further comprises generating one or more second electronic instructions to complete the execution of the transaction in accordance with the first transaction terms and the at least one of the second transaction terms.

8. The method of claim 6, wherein the second response comprises a request to cancel the transaction, and wherein the method further comprises generating one or more second electronic instructions to cancel the execution of the transaction in response to the cancellation request.

9. A system, comprising:
a storage device; and
at least one processor coupled to the storage device, the storage device storing software instructions for controlling the at least one processor when executed by the at least one processor, and the at least one processor is operative with the software instructions and is configured to:
obtain one or more first terms of a transaction, the transaction having a set of second terms used to execute the transaction,
identify an interruption in an execution of the transaction,
determine, in response to the identified interruption, whether the first transaction terms include a predetermined subset of the second transaction terms, and
generate one or more first electronic instructions to complete the execution of the transaction, when the first transaction terms include at least the predetermined subset of the second transaction terms.

10. The system of claim 9, wherein the at least one processor is further configured to receive a request from a user to execute the transaction, the request comprising the first transaction terms, and the transaction comprising at least one of a fund transfer, a bill payment, a purchase of one or more financial instruments, a sale of one or more financial instruments, a deposit, a withdrawal, or an application for credit.

11. The system of claim 10, wherein the at least one processor is further configured to:
determine whether the user is eligible to complete the transaction, the determination of eligibility being based on at least one of an identity of the user, an account of the user, or a type of the transaction; and
generate the one or more first electronic instructions to complete the execution of the transaction in accordance with the first transaction terms when:
the first transaction terms include the predetermined subset of the second transaction terms, and
the user is determined to be eligible.

12. The system of claim 10, wherein the at least one processor is further configured to:
obtain a time corresponding to the identified interruption;
determine whether the obtained time occurs within a threshold time period of a current time; and
generate the one or more first electronic instructions to complete the execution of the transaction in accordance with the first transaction terms when:
the first transaction terms include the predetermined subset of the second transaction terms, and
the interruption time occurs within the threshold time period of the current time.

13. The system of claim 9, wherein the at least one processor is further configured to:
when the first transaction terms include the predetermined subset of the necessary transaction terms, generate one or more second electronic instructions to transmit, to a device of a user, a first message requesting a confirmation of an intention of the user to execute the transaction; and
receive a first response to the first message, the first response comprising at least one of:
a first request to complete the execution of the transaction,
a second request to cancel the execution of the transaction, or
a third request to delay the execution of the transaction.

14. The system of claim 13, wherein the first response comprises the first request, and wherein the at least one processor is further configured to, in response to the first request, generate the one or more first electronic instructions to complete the execution of the transaction in accordance with the first transaction terms.

15. The system of claim 13, wherein the first response comprises the second request, and the at least one processor is further configured to, in response to the second request, generate one or more third electronic instructions to cancel the execution the transaction.

16. The system of claim 13, wherein the first response comprises the third request, and the at least one processor is further configured to, in response to the third request, generate one or more third electronic instructions to delay the execution the transaction for at least one of a predetermined time period or a time period specified in the third request.

17. The system of claim 9, wherein the at least one processor is further configured to:
when first parameters do not include the predetermined subset of the second transaction terms, generate one or more second electronic instructions to transmit, to a device of a user, a second message requesting the at least one of the second transaction terms; and
receive a second response to the second message.

18. The system of claim 17, wherein the second response comprises the at least one of the second transaction terms, and the at least one processor is further configured to generate one or more second electronic instructions to complete the execution of the transaction in accordance with the first transaction terms and the at least one of the second transaction terms.

19. The system of claim 17, wherein the second response comprises a request to cancel the transaction, and the at least one processor is further configured to generate one or more second electronic instructions to cancel the execution of the transaction in response to the cancellation request.

20. A tangible, non-transitory computer-readable medium storing instructions that, when executed by at least one processor, cause the at least one processor to perform a method, comprising:
obtaining one or more first terms of a transaction, the transaction having a set of second terms used to execute the transaction;
identifying an interruption in an execution of the transaction;
determining, in response to the identified interruption, whether the first transaction terms include a predetermined subset of the second transaction terms; and
generating one or more first electronic instructions to complete the execution of the transaction, when the first transaction terms include at least the predetermined subset of the second transaction terms.
